(19) United States
(12) Patent Application Publication
(10) Pub. No.: US 2015/0291175 A1
(43) Pub. Date: Oct. 15, 2015

(54) CONTROL SYSTEM FOR HYBRID VEHICLE

(71) Applicants: Taku HARADA, (US); Masatoshi ITO, (US)

(72) Inventors: Taku Harada, Nisshin-shi (JP); Masatoshi Ito, Okazaki-shi (JP)

(73) Assignee: TOYOTA JIDOSHA KABUSHIKI KAISHA, Toyota-shi, Aichi-ken (JP)

(21) Appl. No.: 14/427,420

(22) PCT Filed: Dec. 9, 2013
(86) PCT No.: PCT/IB2013/002708

§ 371 Date: Mar. 11, 2015

(30) Foreign Application Priority Data
Dec. 26, 2012 (JP) 2012-282180

(51) Int. Cl. B60W 30/20; B60W 10/06; B60W 10/08; B60W 20/00

(52) U.S. Cl. CPC B60W 30/20; B60W 20/106; B60W 10/06; B60W 10/08; B60W 2030/206; B60W 2520/10; B60W 2710/0666; B60W 2710/086; Y10S 903/93

(57) ABSTRACT

In a control system for a hybrid vehicle including an engine, a motor-generator, a power distribution/integration mechanism having three rotary elements connected to a crankshaft, a rotary shaft of the motor-generator, and a ring gear shaft, a motor-generator, and a battery, a battery ECU sets a required charging power to a required charging power that is lower than a normally set required charging power, under a condition that the vehicle speed is lower than a given speed, so that torque fluctuation of the engine is absorbed by hysteresis torque generated by a hysteresis mechanism.

### BACKGROUND OF THE INVENTION

1. Field of the Invention

The invention relates to a vehicular control system used in a so-called hybrid vehicle on which an internal combustion engine and an electric motor(s) are installed as drive sources.

2. Description of Related Art

A known example of this type of hybrid vehicle includes a planetary gear mechanism having three rotary elements connected to a drive shaft coupled to an axle, an output shaft of an engine, and a rotary shaft of a motor-generator MG1, and a motor-generator MG2 capable of generating power to the drive shaft (see, for example, Japanese Patent Application Publication No. 2009-248913 (JP 2009-248913 A)). In the hybrid vehicle, a damper that absorbs torque fluctuation is provided between the engine and the planetary gear mechanism.

In the hybrid vehicle as described above, if the remaining capacity of the battery is reduced, the engine may be operated so as to charge the battery, in a low-speed high-torque region in which vibrations and abnormal noise are likely to be generated. At this time, if the vehicle speed is low, the vibrations and abnormal noise caused by the operation of the engine in the low-speed high-torque region are not masked by vibrations and abnormal noise caused by running of the vehicle; therefore, the electric power for charging the battery is limited to a low level, so that the engine is prevented from being operated in the low-speed high-torque region.

### SUMMARY OF THE INVENTION

In the hybrid vehicle as described in JP 2009-248913 A, vibrations are suppressed by absorbing torque fluctuation of the engine through application of hysteresis torque of the damper. However, it is not considered at all to set the required charging power in view of its relationship with the hysteresis torque of the damper.

Therefore, if the required charging power with which hysteresis torque cannot be applied is generated, torque fluctuation of the engine is directly transmitted to the planetary gear mechanism, and the performance in suppression of vibrations and abnormal noise may deteriorate.

In particular, if the required charging power is set to a high level when the hybrid vehicle switches from the EV running mode to the engine running mode, for example, the amount of change of the required charging power becomes large, and the range of fluctuation of engine torque becomes large, whereby the driver is more likely to feel the vibrations and abnormal noise.

The invention provides a control system for a hybrid vehicle, which provides improved performance in suppression of vibrations and abnormal noise caused by operation of an internal combustion engine, in vehicle running conditions in which the driver is likely to feel the vibrations and abnormal noise.

A control system for a hybrid vehicle according to the invention includes an internal combustion engine, a generator, a planetary gear mechanism, an electric motor, a power storage device, a damper device, a detector, and an electronic control unit. The generator receives power or generates power. The planetary gear mechanism has three rotary elements connected to an output shaft of the internal combustion engine, a rotary shaft of the generator, and a drive shaft coupled to drive wheels, respectively. The electric motor receives power from the drive shaft or generates power to the drive shaft. The power storage device supplies and receives electric power to and from the generator and the electric motor. The damper device is placed in a power transmission path between the internal combustion engine and the planetary gear mechanism. The damper device has a hysteresis mechanism that generates hysteresis torque with frictional force generated by a friction material. The detector detects a vehicle speed of the hybrid vehicle. The electronic control unit is configured to set required electric power that is required to charge the power storage device, based on a state of charge of the power storage device. The electronic control unit is configured to reduce the required electric power as the vehicle speed detected by the detector is lower, so that rotation fluctuation of the output shaft of the internal combustion engine is absorbed by the hysteresis torque generated by the hysteresis mechanism.

With the above arrangement, the control system according to the invention reduces the required charging power as the vehicle speed is lower, so that rotation fluctuation of the output shaft of the internal combustion engine is absorbed by hysteresis torque generated by the hysteresis mechanism. It is thus possible to reduce torque generated by the internal combustion engine, in a low-vehicle-speed region in which the rotation fluctuation is likely to be transmitted to the planetary gear mechanism. Therefore, the control system according to the invention makes it possible to apply hysteresis torque against the rotation fluctuation in the low-vehicle-speed region. Accordingly, the control system according to the invention provides improved performance in suppression of vibrations and abnormal noise caused by operation of the internal combustion engine, in running conditions in which the driver is likely to feel the vibrations and abnormal noise, as compared with the known system.

In the control system as described above, the hysteresis mechanism may include a first hysteresis generating portion that generates first hysteresis torque depending on a torsion angle of the damper device, and a second hysteresis portion that generates second hysteresis torque that is larger than the first hysteresis torque, depending on the torsion angle, and the electronic control unit may be configured to reduce the required electric power as the vehicle speed detected by the detector is lower, so that the rotation fluctuation is absorbed by the first hysteresis torque generated by the first hysteresis generating portion.

With the above arrangement, the control system according to the invention reduces the required charging power as the vehicle speed is lower, so that rotation fluctuation of the output shaft of the internal combustion engine is absorbed by the first hysteresis torque that is smaller than the second hysteresis torque; therefore, the first hysteresis torque can be applied against the rotation fluctuation in the low-vehicle-speed region. Accordingly, even in the case where the damper device is in the form of a so-called two-stage hysteresis damper that generates first hysteresis torque and second hysteresis torque depending on the torsion angle, the control system according to the invention provides improved performance in suppression of vibrations and abnormal noise caused by operation of the internal combustion engine, in running conditions in which the driver is likely to feel the vibrations and abnormal noise.

In the control system as described above, the electronic control unit may be configured to calculate required driving force that is required of the hybrid vehicle, and the electronic control unit may be configured to reduce the required electric power as the calculated required driving force is lower, so that the rotation fluctuation is absorbed by the first hysteresis torque generated by the first hysteresis generating portion.

With the above arrangement, the control system according to the invention reduces the required charging power as the required driving force is smaller, so that rotation fluctuation of the output shaft of the internal combustion engine is absorbed by the first hysteresis torque that is smaller than the second hysteresis torque; therefore, the torque generated by the internal combustion engine can be reduced in a region in which the required driving force is small and the rotation fluctuation is likely to be transmitted to the planetary gear mechanism. Thus, in the control system according to the invention, the first hysteresis torque can be applied against the rotation fluctuation, in the region in which the required driving force is small. Accordingly, the control system according to the invention provides improved performance in suppression of vibrations and abnormal noise caused by operation of the internal combustion engine, in running conditions in which the driver is likely to feel the vibrations and abnormal noise, as compared with the known system.

According to the invention, the control system for the hybrid vehicle provides improved performance in suppression of vibrations and abnormal noise caused by operation of the internal combustion engine, in running conditions in which the driver is likely to feel the vibrations and abnormal noise.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view showing the construction of a hybrid vehicle in which a vehicular control system according to a first embodiment of the invention is used;

FIG. 2 is a view showing a model of a two-stage hysteresis damper according to the first embodiment of the invention;

FIG. 3 is a cross-sectional view of the two-stage hysteresis damper according to the first embodiment of the invention;

FIG. 4 is a graph indicating the relationship between engine torque and the required charging power;

FIG. 5 is a graph indicating the relationship between the torsion angle of a known two-stage hysteresis damper and engine torque;

FIG. 6 is a view showing a rattle audible region defined using the vehicle speed and the required driving force as parameters;

FIG. 7 is a flowchart illustrating required charging power reduction control executed by an ECU according to the first embodiment of the invention;

FIG. 8 is a graph indicating the relationship between the torsion angle of the two-stage hysteresis damper according to the first embodiment of the invention and the engine torque;

FIG. 9 is a flowchart illustrating required charging power reduction control executed by an ECU according to a second embodiment of the invention; and

FIG. 10 is a flowchart illustrating required charging power reduction control executed by an ECU according to a third embodiment of the invention.

### DETAILED DESCRIPTION OF EMBODIMENTS

Some embodiments of the invention will be described with reference to the drawings.

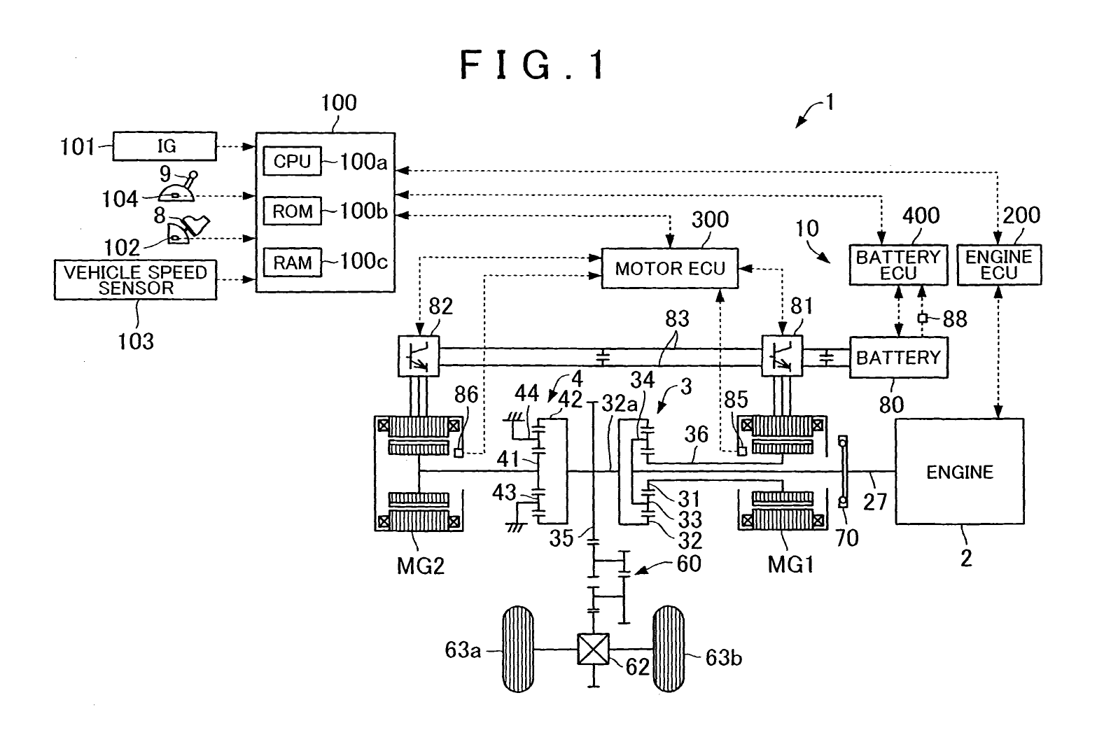

Referring to FIG. 1 through FIG. 8, a control system for a vehicle according to a first embodiment of the invention will be described. The vehicular control system according to this embodiment is used in a so-called hybrid vehicle on which an internal combustion engine and an electric motor(s) (or generator(s)) are installed as power sources for generating driving force of the vehicle.

As shown in FIG. 1, the hybrid vehicle 1 includes an engine 2, a power distribution/integration mechanism 3, motor-generators MG1, MG2, a reduction gear 4, a battery 80, and a vehicular control system 10.

The vehicular control system (electronic control unit) 10 includes an electronic control unit for hybrid vehicle (which will be simply called “HVECU”) 100, an electronic control unit for engine (which will be simply called “engine ECU”) 200, an electronic control unit for motors (which will be simply called “motor ECU”) 300, and an electronic control unit for battery (which will be simply called “battery ECU”) 400. In this embodiment, the vehicular control system 10 provides the electronic control unit device according to the invention.

The engine 2 is constructed as an internal combustion engine capable of generating power with a hydrocarbon-containing fuel, such as gasoline or light oil. In the engine 2, gasoline is injected from a fuel injection valve (not shown) and mixed with intake air, so that a mixture of the fuel and air is drawn into a combustion chamber of each cylinder. Then, the air-fuel mixture is exploded and burned in the combustion chamber, so that a piston (not shown) received in each cylinder of the engine 2 is pushed down with the combustion energy, and the reciprocating motion of the piston is converted into rotary motion of a crankshaft 27 of the engine 2.

The engine 2 is controlled by the engine ECU 200. Various sensors, such as a crank angle sensor and a water temperature sensor, are connected to the engine ECU 200. The engine ECU 200 calculates the engine speed, based on a signal received from the crank angle sensor, for example. The engine ECU 200 outputs various control signals for driving the engine 2, including a drive signal to the fuel injection valve, a drive signal to a throttle motor that adjusts the throttle opening, and a drive signal to an ignition coil, via an output port.

The engine ECU 200 communicates with the HVECU 100, and controls operation of the engine 2 according to a control signal from the HVECU 100. The engine ECU 200 also outputs data concerning operating conditions of the engine 2 to the HVECU 100 as needed.

The power distribution/integration mechanism 3 is a three-shaft-type power distribution/integration mechanism connected to the crankshaft 27 via a damper device 70. The power distribution/integration mechanism 3 includes a sun gear 31 as an externally-toothed gear, a ring gear 32 as an internally-toothed gear disposed concentrically with the sun gear 31, two or more pinion gears 33 that mesh with the sun gear 31 and the ring gear 32, and a carrier 34 that holds the two or more pinion gears 33 such that the pinion gears 33 can rotate about themselves and also rotate about the axis of the mechanism 3. Namely, the power distribution/integration mechanism 3 is in the form of a planetary gear mechanism that performs a differential operation using the sun gear 31, ring gear 32, and the carrier 34 as rotary elements. These three rotary elements are respectively connected to three shafts, i.e., a rotary shaft 36 of a motor-generator MG1 (which will be described later) with which the sun gear 31 can rotate as a unit, a ring gear shaft 32a as a drive shaft coupled to drive wheels 63a, 63b via a counter drive gear 35 and a gear mechanism 60, and the crankshaft 27 as an output shaft of the engine 2.

The carrier 34 is coupled to the crankshaft 27, and the sun gear 31 is coupled to the motor-generator MG1. Also, the ring gear 32 is coupled to the reduction gear 4 via the ring gear shaft 32a. The counter drive gear 35 is coupled to the ring gear shaft 32a. The counter drive gear 35 meshes with the gear mechanism 60.

When the motor-generator MG1 functions as a generator, the power distribution/integration mechanism 3 distributes power received from the engine 2 via the carrier 34, to the sun gear 31 side and the ring gear 32 side, according to the gear ratio thereof When the motor-generator MG1 functions as an electric motor, on the other hand, the power distribution/integration mechanism 3 integrates or combines power received from the engine 2 via the carrier 34 and power received from the motor-generator MG1 via the sun gear 31, and generates the resulting power to the ring gear 32 side. The power transmitted to the ring gear 32 is finally delivered to the drive wheels 63a, 63b of the vehicle, via the counter drive gear 35, gear mechanism 60, and a differential gear 62.

The reduction gear 4 includes a sun gear 41 coupled to the motor-generator MG2, a ring gear 42 disposed concentrically with the sun gear 41, two or more pinion gears 43 that mesh with the sun gear 41 and the ring gear 42, and a carrier 44 having support shafts that support the pinion gears 43 at the other ends thereof such that the pinion gears 43 can rotate about themselves. The reduction gear 4 provides a planetary gear mechanism that has the sun gear 41, ring gear 42, and pinion gears 43 as rotary elements, and is operable to amplify drive torque by reducing the speed of rotation transmitted from the motor-generator MG2.

When the motor-generator MG2 functions as an electric motor, the reduction gear 4 reduces the speed of rotation transmitted from the motor-generator MG2 so as to amplify the drive torque, and delivers the torque from the ring gear 42. On the other hand, the reduction gear 4 increases the speed of rotation caused by power received from the ring gear 42 so as to attenuate or reduce drive torque, and delivers the torque from the sun gear 41 so that the motor-generator MG2 functions as a generator.

Each of the motor-generators MG1, MG2 is constructed as a known synchronous generator-motor, which functions as an electric motor that converts electric power supplied thereto, into mechanical power, and also functions as a generator that converts mechanical power received, into electric power. Namely, each of the motor-generators MG1, MG2 is constructed as a generator and an electric motor, which are able to generate and receive power. The motor-generator MG1 is mainly used as a generator, and the motor-generator MG2 is mainly used as an electric motor. The motor-generator MG1 of this embodiment provides the generator according to the invention, and the motor-generator MG2 provides the electric motor according to the invention.

The motor-generators MG1, MG2 supply and receive electric power to and from the battery 80 via inverters 81, 82, respectively. A power line 83 that connects the inverters 81, 82 with the battery 80 consists of a positive bus and a negative bus, which are commonly used by the inverters 81, 82. With this arrangement, electric power generated by one of the motor-generators MG1, MG2 can be consumed by the other motor-generator. Accordingly, the battery 80 may be charged with electric power generated by either of the motor-generators MG1, MG2, and may discharge or supply electric power to either of the motor-generators MG1, MG2. If the amounts of electric power supplied to and received from the motor-generator MG1 are balanced with those of the motor-generator MG2, the battery 80 will not be put on charge or discharge.

The motor-generators MG1, MG2 are both controlled by the motor ECU 300. The motor ECU 300 receives signals needed to control driving of the motor-generators MG1, MG2, including, for example, signals from rotational position detection sensors 85, 86 that detect the rotational positions of rotors of the motor-generators MG1, MG2, and phase currents applied to the motor-generators MG1, MG2 and detected by current sensors (not shown). The motor ECU 300 outputs switching control signals to the inverters 81, 82.

The motor ECU 300 communicates with the HVECU 100, and controls driving of the motor-generators MG1, MG2 according to a control signal from the HVECU 100. The motor ECU 300 also outputs data concerning operating conditions of the motor-generators MG1, MG2 to the HVECU 100 as needed. The motor ECU 300 calculates the rotational speeds Nm1, Nm2 of the motor-generators MG1, MG2, based on signals from the rotational position detection sensors 85, 86.

The battery 80 is constructed as a secondary battery, such as a nickel hydride battery or a lithium-ion battery, which is capable of charging and discharging. The battery 80 is arranged to supply and receive electric power to and from the motor-generators MG1, MG2. In this embodiment, the battery 80 provides the power storage device according to the invention.

The battery 80 is managed by the battery ECU 400. The battery ECU 400 receives signals needed to manage the battery 80, including a voltage between the terminals of the battery 80 from a voltage sensor (not shown) installed between the terminals, a charge/discharge current from a current sensor (not shown) mounted in the power line 83 connected to the output terminal of the battery 80, and a battery temperature Tb from a battery temperature sensor 88 mounted in the battery 80.

The battery ECU 400 outputs data concerning conditions of the battery 80 to the HVECU 100 as needed, via communications. Also, the battery ECU 400 calculates the remaining capacity (SOC) based on the integrated value of the charge/discharge current detected by the current sensor, so as to manage the battery 80, and calculates input and output limits Win, Wout as the maximum permissible electric power with which the battery 80 can be charged and the maximum permissible electric power that can be discharged from the battery 80, based on the calculated remaining capacity (SOC) and the battery temperature Tb. For example, the input and output limits Win, Wout can be set by multiplying each of their temperature-dependent values based on the battery temperature Tb, by a correction coefficient for the input limit or a correction coefficient for the output limit, which is based on the remaining capacity (SOC) of the battery 80. The input and output limits Win, Wout may also be obtained by referring to an input/output limit map in which the input/output limit Win, Wout is associated with the remaining capacity (SOC) and the battery temperature Tb.

The battery ECU 400 calculates required charging power Pchg required to charge the battery 80, based on the state of charge (SOC), or remaining capacity, of the battery 80, and sets the calculated required charging power Pchg. Namely, the battery ECU 400 sets the require charging power Pchg so as to keep the remaining capacity (SOC) of the battery 80 at a given control target (e.g., control center).

The required charging power Pchg is set to a positive value (Pchg>0) when the battery 80 is to be charged, and is set to a negative value (Pchg<0) when the battery 80 is to be discharged. In this embodiment, when the battery 80 should be charged, namely, when a request for charging is issued, the above-described required charging power Pchg is changed according to the vehicle speed V, as will be described later.

The HVECU 100 is configured as a microprocessor having CPU 100a as a main component, and further includes ROM 100b that stores processing programs, RAM 100c that temporarily stores data, and input and output ports and communication port (not shown).

An ignition switch 101, accelerator pedal position sensor 102, vehicle speed sensor 103, and a shift position sensor 104 are connected to the HVECU 100. The ignition switch 101 outputs an ignition signal to the HVECU 100, according to the user's operation. The accelerator pedal position sensor 102 detects the accelerator pedal position Acc based on the operation amount of the accelerator pedal 8, and outputs a signal indicative of the accelerator pedal position Acc to the HVECU 100. The vehicle speed sensor 103 detects the vehicle speed V of the hybrid vehicle, and outputs a signal indicative of the vehicle speed V to the HVECU 100. In this embodiment, the vehicle speed sensor 103 provides the detector according to the invention.

The shift position sensor 104 detects the operation position (shift position SP) of the shift lever 9, and outputs a signal indicative of the shift position SP to the HVECU 100. The shift position SP may be selected from, for example, a parking position (P position) for parking, a running position (D position) for forward running, a reverse position (R position) for reverse running, and so forth.

The HVECU 100 is connected to the engine ECU 200, motor ECU 300, and the battery ECU 400, via the communication port, as described above, and supplies and receives various control signals and data to and from the engine ECU 200, motor ECU 300, and the battery ECU 400.

In the hybrid vehicle 1 constructed as described above, the required driving force F of the vehicle as a whole is calculated based on the accelerator operation amount Acc and the vehicle speed V, and the engine 2 and the motor-generators MG1, MG2 are controlled so that required power corresponding to the required driving force F is delivered to the counter drive gear 35. For example, the HVECU 100 sets engine power Pe required to be generated from the engine 2, by adding the above-mentioned required charging power Pchg and a loss Loss, to a value obtained by multiplying the calculated required driving force F by the rotational speed Nr of the ring gear shaft 32a. Also, the HVECU 100 calculates the engine speed and the engine torque, from the thus set engine power Pe, using an optimum fuel efficiency line.

In this connection, a map (not shown) that defines the relationship between the accelerator operation amount Acc and the vehicle speed V, and the required driving force F, is empirically obtained in advance, and stored in the ROM 100b of the HVECU 100. The HVECU 100 can calculate the required driving force F required of the hybrid vehicle 1, referring to the map, based on the accelerator operation amount Acc and the vehicle speed V.

The running mode of the hybrid vehicle 1 may be selected from, for example, a hybrid running mode, a motor running mode, a regeneration running mode, and so forth.

In the hybrid running mode, the hybrid vehicle 1 runs using both the engine 2 and the motor-generator MG2 as sources of driving force, while causing the motor-generator MG1 to generate electric power utilizing the output of the engine 2. In the motor running mode, the hybrid vehicle 1 runs using the motor-generator MG2 as a source of driving force, in a condition where the engine is stopped. In the regeneration running mode, when a certain condition, such as a deceleration request, is satisfied, the motor-generator MG2 generates electric power using energy received via the gear mechanism 60.

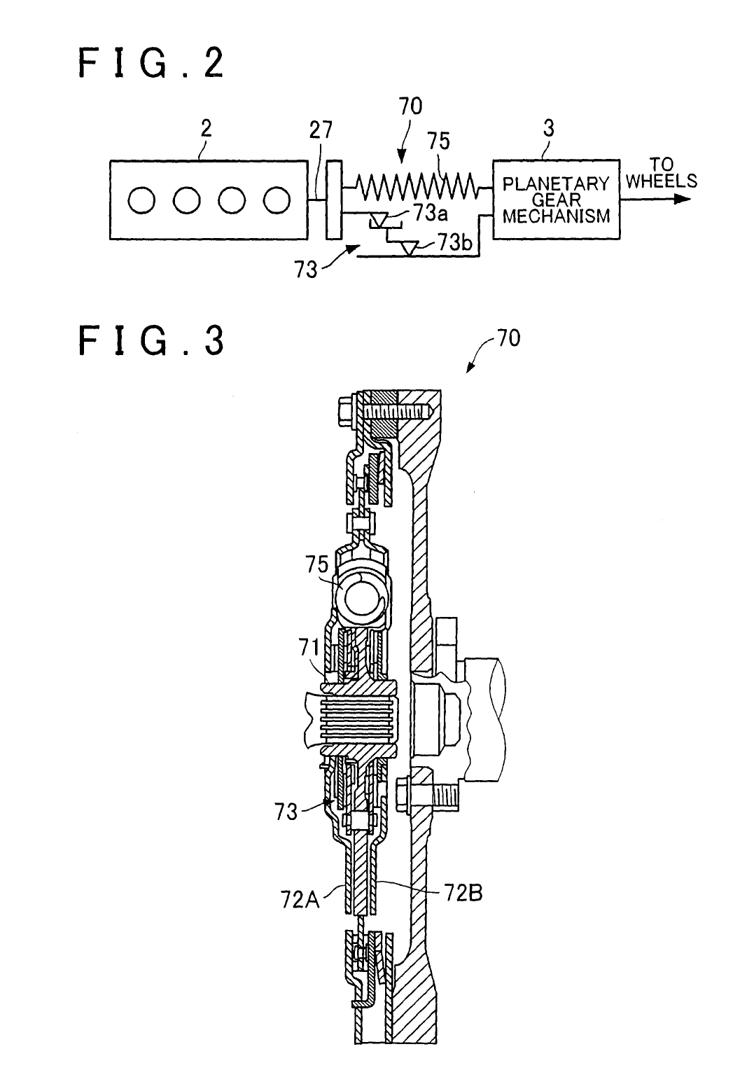

Referring next to FIG. 2 and FIG. 3, the damper device 70 according to this embodiment will be described.

As shown in FIG. 2, the damper device 70 is placed in a power transmission path between the engine 2 and the planetary gear mechanism 3. As shown in FIG. 3, the damper device 70 includes a hub 71, a pair of side plates 72A, 72B, and a hysteresis mechanism 73 located between the hub 71 and the side plates 72A, 72B. The hysteresis mechanism 73 serves to absorb torque fluctuation (rotation fluctuation) of the engine 2.

The hysteresis mechanism 73 is arranged to generate hysteresis torque with frictional force generated by a friction material (to which no reference numeral is assigned), so as to absorb torque fluctuation (rotation fluctuation) of the engine 2. The friction material is provided between the hub 71 and the pair of side plates 72A, 72B, and generates given hysteresis torque when the hub 71 and the pair of side plates 72A, 72B rotate relative to each other.

As shown in FIG. 2, the hysteresis mechanism 73 includes a first hysteresis generating portion 73a that generates first hysteresis torque depending on the torsion angle, and a second hysteresis generating portion 73b that generates second hysteresis torque that is larger than the first hysteresis torque, depending on the torsion angle.

The first hysteresis generating portion 73a uses a low friction material as the above-mentioned friction material. On the other hand, the second hysteresis generating portion 73b uses a high friction material as the friction material.

Namely, the damper device 70 according to this embodiment is a so-called two-stage hysteresis damper, which has two hysteresis generating portions that generate different hysteresis torques depending on the torsion angle. With this arrangement, the damper device 70 attenuates low-torque vibrations and also avoids excessively large torque generated at the time of start and stop of the engine 2, by means of the two hysteresis generating portions 73a, 73b.

The damper device 70 also includes a coil spring 75 that functions as a damper. Accordingly, the hub 71 and the pair of side plates 72A, 72B rotate relative to each other via the coil spring 75.

In a known hybrid vehicle having the two-stage hysteresis damper as described above, when the SOC of the battery is reduced, the required charging power is set to a large value in the hybrid running mode, for example, so as to charge the battery. In this case, the engine may be operated in a low-rotational-speed high-torque region so that the required charging power can be ensured.

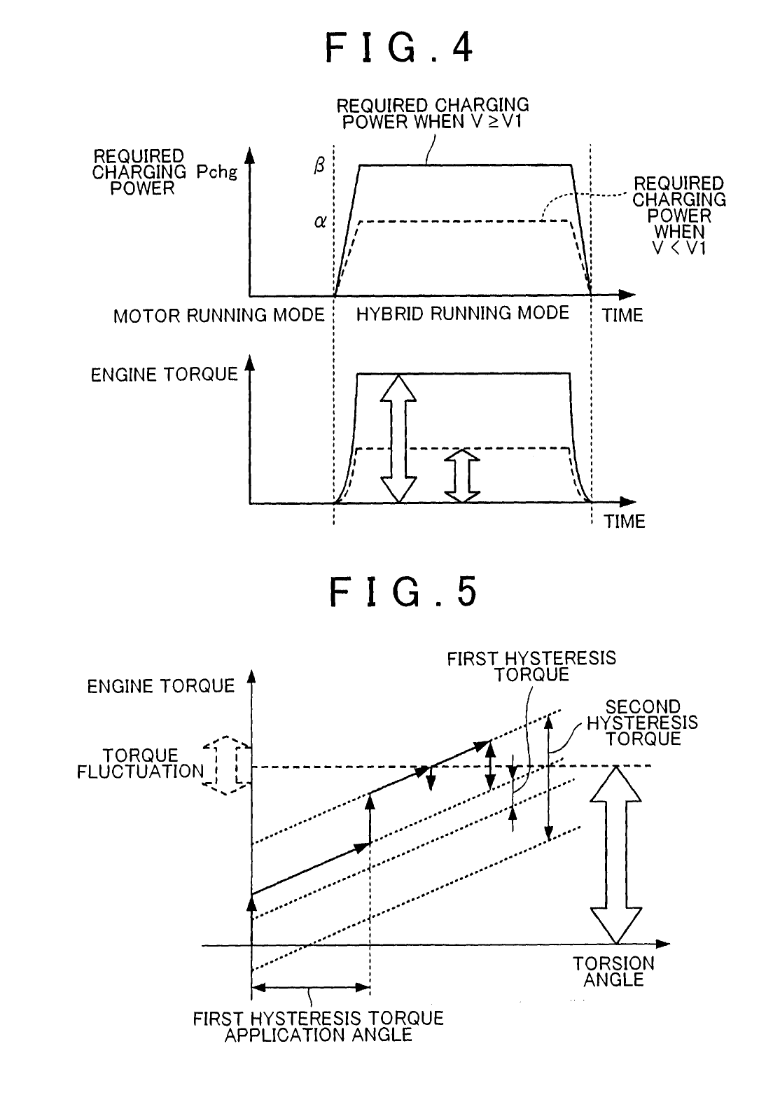

FIG. 4 shows changes in the required charging power and engine torque when the hybrid vehicle switches from the motor running mode to the hybrid running mode.

For example, if the required charging power (=β) at the time of switching from the motor running mode to the hybrid running mode is large, as shown in FIG. 4, the amount of change of the required charging power is increased, and the range of fluctuation of the engine torque (indicated by a solid line in FIG. 4) is increased accordingly.

Therefore, in the known two-stage hysteresis damper, the torsion angle is increased, and the second hysteresis torque that is larger than the first hysteresis torque is applied, as shown in FIG. 5. As a result, further torsion is restricted in the hysteresis mechanism, and no further hysteresis torque can be applied. Consequently, torque fluctuation of the engine is directly transmitted to the planetary gear mechanism, resulting in deterioration of the performance in suppression of vibrations and abnormal noise.

At this time, if the vehicle speed is relatively high, vibrations and abnormal noise caused by running of the vehicle can mask the vibrations and abnormal noise caused by operation of the engine in the low-speed high-torque region. If the vehicle speed is low, however, these vibrations and abnormal noise cannot be masked.

According to the related art, in order to suppress the vibrations and abnormal noise, the engine speed is increased and the engine torque is reduced, so that the engine is prevented from being operated in the low-speed high-torque region in which such vibrations and abnormal noise are likely to occur. However, if this method is employed, new problems, such as noise caused by racing of the engine and deterioration of the fuel economy, may arise.

Thus, in this embodiment, required charging power reduction control for reducing the required charging power Pchg is executed when the vehicle speed V is in a low-vehicle-speed region in which the driver is likely to feel vibrations and abnormal noise, in order to improve the performance in suppression of vibrations and abnormal noise. The required charging power reduction control is executed by the battery ECU 400.

More specifically, when the vehicle speed V detected by the vehicle speed sensor 103 (see FIG. 1) is smaller than a predetermined or given vehicle speed V1 (V<V1), the battery ECU 400 executes the required charging power reduction control to reduce the required charging power Pchg, so that torque fluctuation of the engine 2 is absorbed by the first hysteresis torque generated by the first hysteresis generating portion 73a.

Namely, when the vehicle speed V is smaller than the given vehicle speed V1 (V<V1), the battery ECU 400 sets the required charging power Pchg to a required charging power Pchg_α (see FIG. 4) that is lower than a required charging power Pchg_β to which the required charging power Pchg is normally set, under the required charging power reduction control.

The given vehicle speed V1 is a vehicle speed based on which it is determined whether the vehicle (i.e., vehicle running conditions) is within a region (which will be called “rattle audible region”) in which the driver can hear vibrations and abnormal noise, in particular, rattle. The vehicle speed V1 is empirically obtained in advance and stored in the ROM of the battery ECU 400.

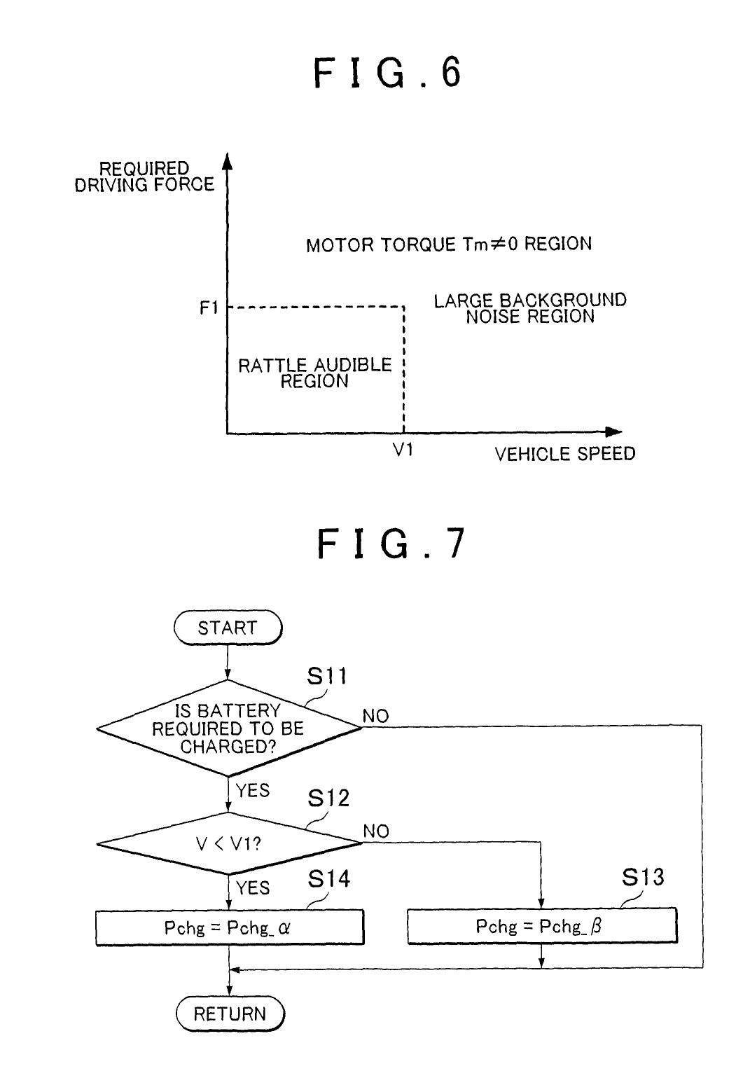

FIG. 6 is a view showing the rattle audible region using the vehicle V and the required driving force F as parameters. As shown in FIG. 6, a region in which the vehicle speed V is lower than the vehicle speed V1 and the required driving force F is smaller than the required driving force F1 is designated as the rattle audible region. In a region in which the vehicle speed V is equal to or higher than the vehicle speed V1, rattle is masked by background noise. In a region in which the required driving force F is equal to or larger than the required driving force F1, motor torque Tm is produced by the motor-generator MG2, so that gear rattle, or the like, which could cause the above-mentioned rattle, is less likely or unlikely to arise in the planetary gear mechanism 3 or the reduction gear 4.

In this embodiment, when the vehicle speed V is lower than the given vehicle speed V1 (V<V1), the required charging power Pchg is uniformly set to the required charging power Pchg_α. However, the required charging power Pchg is not necessarily set in this manner, but may be reduced as the vehicle speed V is lower, for example.

Referring next to FIG. 7, the required charging power reduction control executed by the battery ECU 400 according to this embodiment will be described. The required charging power reduction control is executed by the battery ECU 400 at given time intervals.

As shown in FIG. 7, the battery ECU 400 determines whether the battery 80 is required to be charged (step S11). The battery ECU 400 can determine whether the battery 80 is required to be charged, by determining whether the SOC of the battery 80 is reduced, namely, whether the SOC is equal to or smaller than a given value.

If the battery ECU 400 determines that the battery 80 is not required to be charged, this cycle of the routine of FIG. 7 ends. On the other hand, if the battery ECU 400 determines that the battery 80 is required to be charged, it determines whether the vehicle speed V is lower than the given vehicle speed V1 (step S12). The vehicle speed V is detected by the vehicle speed sensor 103, for example, and is sent to the battery ECU 400 via the HVECU 100.

When the battery ECU 400 determines that the vehicle speed V is not lower than the given vehicle speed V1, namely, the vehicle speed V is equal to or higher than the given vehicle speed V1, the battery ECU 400 sets the required charging power Pchg to a required charging power Pchg_β (see FIG. 4) to which the required charging power Pchg is normally set (step S13), and this cycle of the routine ends. Here, the normally set required charging power Pchg_β is the required charging power set based on the SOC of the battery 80 as described above.

On the other hand, if the battery ECU 400 determines that the vehicle speed V is lower than the given vehicle speed V1, it sets the required charging power Pchg to a required charging power Pchg_α (see FIG. 4) that is lower than the normally set required charging power Pchg_β, and this cycle of the routine ends.

In this manner, it is possible to reduce the engine power Pe that is set by the HVECU 100 in view of the required charging power Pchg, resulting in reduction of engine torque with which the engine power Pe is generated. Here, the required charging power Pchg_α is set, irrespective of the SOC of the battery 80, so as to provide engine torque that permits the first hysteresis torque to be applied in the damper device 70.

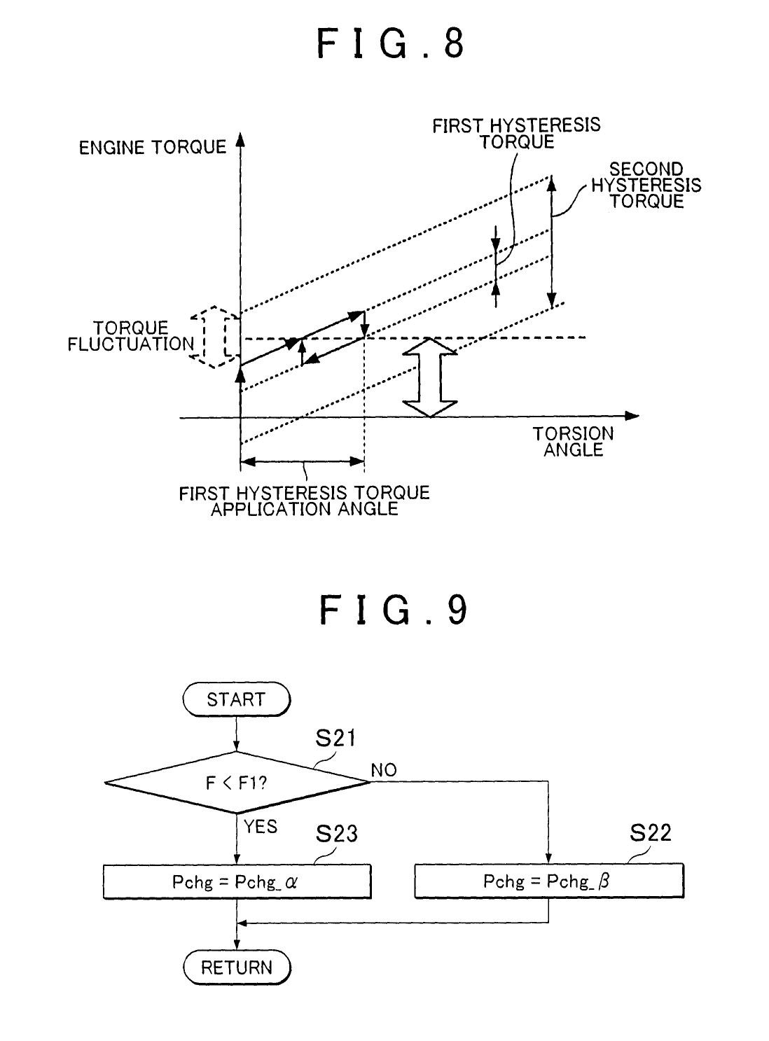

With the required charging power reduction control thus executed, the engine torque can be reduced in the rattle audible region as shown in FIG. 8, as compared with the example shown in FIG. 5. As a result, the torsion angle in the damper device 70 can be held within the range of first hysteresis torque application angle, and the first hysteresis torque can be applied against torque fluctuation. Thus, the torque fluctuation of the engine 2 is attenuated.

As described above, as the vehicle speed V is lower, for example, when the vehicle speed V is lower than the given vehicle speed V1, the vehicular control system 10 according to this embodiment reduces the required charging power Pchg down to the required charging power Pchg_α that is lower than the normally set required charging power Pchg_β, so that torque fluctuation of the engine 2 is absorbed by the first hysteresis torque that is smaller than the second hysteresis torque. Thus, in the low-vehicle-speed region (e.g., in the rattle audible region), the first hysteresis torque can be applied against the torque fluctuation.

Accordingly, even in the case where the damper device 70 is in the form of the two-stage hysteresis damper, which produces first hysteresis torque and second hysteresis torque depending on the torsion angle, the vehicular control system 10 according to this embodiment is able to improve the performance in suppression of vibrations and abnormal noise caused by operation of the engine 2, in running conditions (e.g., in a low-vehicle-speed region) in which the driver is likely to feel the vibrations and abnormal noise.

In the vehicular control system 10 according to this embodiment, there is no need to raise the engine speed so as to suppress vibrations and abnormal noise in the low-vehicle-speed region (e.g., in the rattle audible region) as in the known system; therefore, the above-mentioned problems, such as noise caused by racing of the engine 2 and deterioration of the fuel economy, can be prevented.

Next, a second embodiment of the invention will be described with reference to FIG. 9.

This embodiment is different from the above-described first embodiment in a part of the routine of the required charging power reduction control, but is substantially identical with the first embodiment in the other respects. Accordingly, the same reference numerals are assigned to the same or corresponding components or portions as those of the first embodiment, and these components or portions will not be further described; rather, only a portion of the second embodiment which is different from that of the first embodiment will be described.

As described above with respect to the first embodiment, the vehicle (i.e., vehicle running conditions) is within the rattle audible region when the required driving force F is smaller than the given required driving force F1. Namely, when the required driving force F is smaller than the given required driving force F1, the motor torque Tm of the motor-generator MG2 becomes substantially equal to zero, resulting in a condition where no torque is applied to a gear (e.g., the sun gear 41) coupled to the motor-generator MG2. Therefore, gear rattle may arise in the reduction gear 4 or the planetary gear mechanism 3, and may cause rattling noise in the vehicle.

Accordingly, under the required charging power reduction control of this embodiment, it is determined from the required driving force F, in place of the vehicle speed V, whether the vehicle is within the rattle audible region, and the required charging power Pchg is changed as needed.

In the following, the required charging power reduction control according to this embodiment will be described. In the required charging power reduction control according to this embodiment, the step of determining whether the battery 80 is required to be charged (step S11 in the first embodiment) is the same as that of the first embodiment, and therefore will not be described.

As shown in FIG. 9, the battery ECU 400 determines whether the required driving force F is smaller than a predetermined or given required driving force F1 (step S21). The HVECU 100 calculates the required driving force F based on the accelerator operation amount Acc and the vehicle speed V, and the battery ECU 400 receives the required driving force F thus calculated, from the HVECU 100. The given required driving force F1, which provides a basis for determination as to whether the vehicle is within the rattle audible region (see FIG. 6), is empirically obtained in advance and stored in the ROM of the battery ECU 400.

When the battery ECU 400 determines that the required driving force F is not smaller than the given required driving force F1, namely, the required driving force F is equal to or larger than the given required driving force F1, the battery ECU 400 sets the required charging power Pchg to the normally set required charging power Pchg_β (see FIG. 4) (step S22), and this cycle of the routine of FIG. 9 ends. Here, the normally set required charging power Pchg_β is the required charging power set based on the SOC of the battery 80 as described above.

On the other hand, when the battery ECU 400 determines that the required driving force F is smaller than the given required driving force F1, it sets the required charging power Pchg to the required charging power Pchg_α (see FIG. 4) that is lower than the normally set required charging power Pchg_β (step S23), and this cycle of the routine ends.

As described above, as the required driving force F is lower, for example, when the required driving force F is smaller than the given required driving force F1, the vehicular control system 10 according to this embodiment reduces the required charging power Pchg down to the required charging power Pchg_α that is lower than the normally set required charging power Pchg_β, so that torque fluctuation of the engine 2 is absorbed by the first hysteresis torque that is smaller than the second hysteresis torque. Thus, in the low-vehicle-speed region (e.g., in the rattle audible region), the first hysteresis torque can be applied against the torque fluctuation.

Accordingly, even in the case where the damper device 70 is in the form of the two-stage hysteresis damper, which produces first hysteresis torque and second hysteresis torque depending on the torsion angle, the vehicular control system 10 according to this embodiment is able to improve the performance in suppression of vibrations and abnormal noise caused by operation of the engine 2, in running conditions (e.g., in a low-vehicle-speed region) in which the driver is likely to feel the vibrations and abnormal noise.

With the vehicular control system 10 according to this embodiment, the above-mentioned problems, such as noise caused by racing of the engine 2 and deterioration of the fuel economy, can be prevented, as in the first embodiment.

In this embodiment, when the required driving force F is smaller than the given required driving force F1 (F<F1), the required charging power Pchg is uniformly set to the required charging power Pchg_α. However, the required charging power Pchg is not necessarily set in this manner, but may be reduced as the required driving force F is lower, for example.

In this embodiment, under the required charging power reduction control, it is determined from the required driving force F, in place of the vehicle speed V, whether the vehicle (i.e., vehicle running conditions) is within the rattle audible region, and the required charging power Pchg is changed as needed. However, this invention is not limited to this arrangement, but it may be determined from the vehicle speed V and the required driving force F whether the vehicle is within the rattle audible region, and the required charging power Pchg may be changed as needed. In this case, the rattle audible region can be more appropriately or precisely specified, and the required charging power reduction control is prevented from being unnecessarily executed.

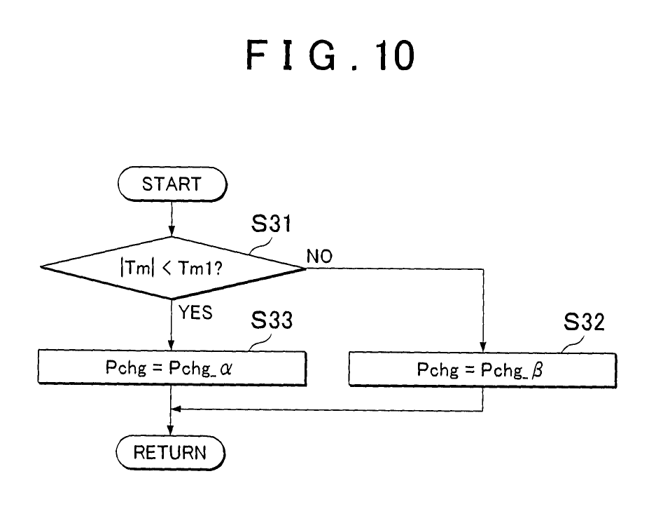

Next, a third embodiment of the invention will be described with reference to FIG. 10.

This embodiment is different from the above-described first and second embodiments in a part of the routine of the required charging power reduction control, but is substantially identical with the first and second embodiments in the other respects. Accordingly, the same reference numerals are assigned to the same or corresponding components or portions as those of the first and second embodiments, and these components or portions will not be further described; rather only a portion of the third embodiment which is different from those of the first and second embodiments will be described.

In the second embodiment as described above, under the required charging power reduction control, it is determined from the required driving force F whether the vehicle is within the rattle audible region, and the required charging power Pchg is changed as needed. In this embodiment, it is determined whether the vehicle (i.e., vehicle running conditions) is within a region in which the motor torque Tm of the motor-generator MG2 is substantially equal to zero, and the required charging power Pchg is changed as needed.

In the following, the required charging power reduction control according to this embodiment will be described. In the required charging power reduction control according to this embodiment, the step of determining whether the battery 80 is required to be charged (step S11 in the first embodiment) is the same as that of the first embodiment, and therefore will not be described.

As shown in FIG. 10, the battery ECU 400 determines whether the absolute value |Tm| of the motor torque Tm is smaller than a predetermined or given motor torque Tm1 (step S31). Namely, the battery ECU 400 determines whether the motor torque Tm of the motor-generator MG2 is larger than a given motor torque −Tm1, and is smaller than a given motor torque Tm1. Namely, the battery ECU 400 determines whether the motor torque Tm is within a predetermined torque range including zero torque (Tm=0). The motor torque Tm is sent from the motor ECU 300 to the battery ECU 400 via the HVECU 100.

In this connection, the given motor torque Tm1 is set to an amount of torque (e.g., 1 Nm) based on which it can be determined that no torque is applied from the motor-generator MG2 to the sun gear 41. The given motor torque Tm1 is stored in advance in the ROM of the battery ECU 400 or the ROM 100b of the HVECU 100.

The motor torque Tm can be derived from the following equation (1), for example. In the following equation (1), F is the required diving force [N] of the hybrid vehicle 1, Tm is the motor torque [N·m] of the motor-generator MG2, Gr is the reduction ratio of the reduction gear 4, Te is the engine torque [N·m], ρ is the planetary gear ratio, ρ_{def} is the differential ratio of the differential gear, and Rt is the diameter of tire [m].

F={(Tm×Gr)+Te×(1/1+ρ)}×ρ_{def}/Rt (1)

If the battery ECU 400 determines that the motor torque Tm is not smaller than the given motor torque Tm1, namely, the motor torque Tm is equal to or larger than the given motor torque Tm1, the battery ECU 400 sets the required charging power Pchg to the normally set required charging power Pchg_β (see FIG. 4) (step S32), and this cycle of the routine of FIG. 10 ends. Here, the normally set required charging power Pchg_β is the required charging power set based on the SOC of the battery 80 as described above.

If the battery ECU 400 determines that the motor torque Tm is smaller than the given motor torque Tm1, on the other hand, it sets the required charging power Pchg to the required charging power Pchg_α (see FIG. 4) that is lower than the normally set required charging power Pchg_β (step S33), and this cycle of the routine ends.

As described above, when the motor torque Tm is smaller than the given motor torque Tm1, the vehicular control system 10 according to this embodiment reduces the required charging power Pchg down to the required charging power Pchg_α that is lower than the normally set required charging power Pchg_β, so that torque fluctuation of the engine 2 is absorbed by the first hysteresis torque that is smaller than the second hysteresis torque. Thus, in the low-vehicle-speed region (e.g., in the rattle audible region), the first hysteresis torque can be applied against the torque fluctuation.

Accordingly, even in the case where the damper device 70 is in the form of the two-stage hysteresis damper, the vehicular control system 10 according to this embodiment is able to improve the performance in suppression of vibrations and abnormal noise caused by operation of the engine 2, in running conditions (e.g., in a low-vehicle-speed region) in which the driver is likely to feel the vibrations and abnormal noise.

In each of the above-described embodiments, the vehicular control system according to the invention is installed on the hybrid vehicle 1 in which the engine 2 and the motor-generators MG1, MG2 are connected via the power distribution/integration mechanism 3 and the reduction gear 4. However, the invention may be applied to other types of hybrid vehicles provided that the hybrid vehicle has two motors, like the motor-generators MG1, MG2, and includes the damper device 70. In particular, a mechanism that connects these power output and input devices (engine and motor-generators MG1, MG2) may be constructed otherwise.

As described above, the vehicular control system according to the invention is able to improve the performance in suppression of vibrations and abnormal noise caused by operation of the internal combustion engine, in running conditions in which the driver is likely to feel the vibrations and abnormal noise, as compared with the known system. Thus, the vehicular control system of the invention is useful as a control system used in a hybrid vehicle.

1. A vehicle control system mounted in a hybrid vehicle, the vehicle control system comprising:
an internal combustion engine;
a generator that receives power or generates power;
a planetary gear mechanism having three rotary elements connected, respectively to three shafts, the three shafts comprising an output shaft of the internal combustion engine, a rotary shaft of the generator, and a drive shaft coupled to drive wheels;
an electric motor that receives power from the drive shaft or generates power to the drive shaft;
a power storage device that supplies and receives electric power to and from the generator and the electric motor;
a damper device placed in a power transmission path between the internal combustion engine and the planetary gear mechanism, the damper device having a hysteresis mechanism that generates hysteresis torque with frictional force generated by a friction material;
a detector that detects a vehicle speed of the hybrid vehicle; and
an electronic control unit configured to set required charging power that is required to charge the power storage device, based on a state of charge of the power storage device, the electronic control unit being configured to reduce the required charging power as the vehicle speed detected by the detector is lower, so that rotation fluctuation of the output shaft of the internal combustion engine is absorbed by the hysteresis torque generated by the hysteresis mechanism.

2. The vehicle control system according to claim 1, wherein:
the hysteresis mechanism includes a first hysteresis generating mechanism that generates first hysteresis torque depending on a torsion angle, and a second hysteresis mechanism that generates second hysteresis torque that is larger than the first hysteresis torque, depending on the torsion angle; and
when the vehicle speed detected by the detector is lower than a predetermined speed, the electronic control unit is configured to reduce the required charging power to provide engine torque that permits application of the first hysteresis torque generated by the first hysteresis generating mechanism.

3. The vehicle control system according to claim 2, wherein
the electronic control unit is configured to calculate required driving force that is required of the hybrid vehicle; and
when the required driving force calculated by the electronic control unit is lower than a predetermined driving force, the electronic control unit is configured to reduce the required charging power to provide engine torque that permits application of the first hysteresis torque generated by the first hysteresis generating mechanism.
